(19) United States
(12) Patent Application Publication
(10) Pub. No.: US 2010/0078470 A1
(43) Pub. Date: Apr. 1, 2010

(54) MEDIA READER DOCKING SYSTEM

(76) Inventor: Sandro F. DalPorto, Ladora Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 12/568,568

(22) Filed: Sep. 28, 2009

Related U.S. Application Data
(60) Provisional application No. 61/101,103, filed on Sep. 29, 2008.

(51) Int. Cl. G06F 17/00; G06K 7/00

(52) U.S. Cl. 235/375; 235/439

(57) ABSTRACT

A media reader docking system is provided for organizing digital content stored on media cards. The system includes a dock for receiving a plurality of media bays. Both the dock and the media bay may be connected to a computer for access to the digital content of the media cards. The media bay is configured to accept a plurality of media cards for storage of the media cards and access to the digital content without requiring the removal of the digital content from the media cards. The dock is expandable to receive more media bays and thus accept more media cards. A collection of digital content may be generated from a series of media cards stored within the media bays. A software program is included to interface between the dock or the media bay and the computer. The media reader docking system provides fast and easy access to the digital content stored on the plurality of media cards inserted within the media bays and secured to the dock.

### CROSS-REFERENCE TO RELATED APPLICATIONS

This application relates to and claims the benefit of U.S. Provisional Application No. 61/101,103 filed Sep. 29, 2008 and entitled MEDIA READER DOCKING SYSTEM, which is wholly incorporated by reference herein.

### STATEMENT RE: FEDERALLY SPONSORED RESEARCH/DEVELOPMENT

Not Applicable

### BACKGROUND

1. Technical Field

The present invention relates generally to a media reader docking system and, more particularly, to a docking system configured to receive a plurality of media bays, wherein each media bay is configured to receive a plurality of media cards for the organization of digital content stored on the media cards.

2. Related Art

The use of media card readers is an efficient method for uploading digital content such as photos, videos, music from a media card to a host computer. The digital content may then be organized on the hard drive of the host computer for storage, safekeeping, viewing, editing for example. Media card readers may plug into the host computer via a serial cable such as universal serial bus (USB) or IEEE 1394 connector. After connecting the media card reader, a compatible media card which may also be referred to as a memory card may be inserted into the media card reader. Upon insertion of the media card, the digital content stored on the media card in the form of files may be transferred from the media card to the host computer without use of the batteries or cables associated with the electronic device in which the digital content was captured and stored onto the media card. When the media card reader is connected to the host computer via the serial cable, a separate, removable drive in the form of an icon may appear on the host computer. Another advantage of using media card readers to transfer digital content onto the host computer includes faster transfer rates. Transferring digital content directly from the device such as a mobile phone, digital camera, camcorder, personal digital assistant (PDA), Smart phone, digital music player or some other digital device may be significantly slower than the transfer rate associated with the media card reader.

Subsequent to the transfer of the digital content, a user of the host computer may organize the digital content, edit, view or simply backup the information. Additionally, once the transfer is complete, the digital content on the media card may be deleted and used to capture more digital content associated with the electronic device in which the media card may be inserted. Alternatively, the digital content on the media card may be kept for backup without requiring the deletion of the digital content stored therein.

The media cards that are inserted into the media card readers are memory cards that may include flash memory and non-flash memory cards. These media cards may be used with a majority of digital devices including digital cameras, handheld and mobile computers, telephones, digital music players, video game consoles, camcorders and other electronic devices. Many of these media cards are preferred because they include solid state electronic flash memory data storage. The advantages of using these types of media cards include low power consumption, minimized physical dimensions and reduced mechanical complexity. Memory cards offer high re-write-ability, power-free storage, small form factor, and rugged environmental specifications. For the foregoing reasons, the use of media cards to store digital content is steadily increasing. Additionally, technological advances has allowed for increased storage capacities associated with media cards while manufacturing costs are steadily decreasing allowing the savings to be passed on to consumers. The advances in the media card industry has provided consumers with the added flexibility of using multiple media cards to store digital content rather than use one media card and then delete the contents for a subsequent use.

A media card reader typically uses a USB interface, for accessing the data on the media card such as a Compact Flash, Secure Digital or Multimedia card. Most media card readers also offer write capability, and together with the media card, this can function as a pen drive. Some printers and personal computers have a built-in media card reader. Card readers can be categorized into three by the type and quantity of the media card slots: single card reader, multi-card reader and series card reader. A multi card reader is a device used for communication with more than one type of flash memory card. Multi card readers do not have any built-in memory capacity, but are able to accept multiple types and styles of media cards. Multi card readers may use a USB interface to connect with a USB-capable computer or other device, enabling users to access information stored on the media card. The number of compatible media cards varies from reader to reader and can include more than 20 different types of media cards. The number of different media cards that a multi card reader can accept is expressed as x-in-1, with x being the number of media cards accepted. For example, if the multi card reader can accept up to 9 different media cards, then the media card reader may be categorized as a 9 in 1 multi card reader. Although a multi card reader may accept more than one type of media card, the multi card reader may not be configured to accept more than one media card of the same format. In this regard, only one media card may be inserted into the media reader, while requiring the removal of the media card prior to inserting a second media card.

Most modern computers have built-in slots that are used as media card readers. A media card is inserted into the slot and read for access to the content stored on the media card. Access to the media card is important in order to transfer the appropriate files and delete files. There are a variety of media cards that are used with electronic devices including by way of example: memory sticks, compact flash, Secure Digital (SD), etc. Because of the wide variety of media cards, some electronic devices support more than one media card to enhance compatibility and provide the consumer with added flexibility in choosing the right media card. Some well known media cards include Compact Flash, SD and Multimedia, xD, memory stick, and microdrive. Compact Flash is one of the most common types of memory associated with digital cameras. Compact Flash media cards may include a controller chip which allows for transfer at high rates. Secure Digital and Multimedia cards are small media cards that may be used with small cameras, PDA's, organizers, phones, and digital music players.

Multi card readers allow for access to digital content stored on a plurality of different types of media cards. However, media card readers appear to lack the capability of receiving a multiple quantity of media cards having the same format. Media card readers may be configured to receive a compact flash card, a USB drive, a microdrive, and a secure digital card when configured with multiple media card slots. Media card readers are used primarily as devices to transfer digital content from a media card to a computer. Media card readers are not used to organize digital content. The emphasis of the media card reader as a transferring tool is due to the re-write-ability of media cards and the substantial cost initially associated with media cards. Subsequent to the transfer, the media card may be deleted or reformatted for reuse. This encourages the use of a media card that may store large quantities of digital content from an electronic device rather than using more than one media card for the electronic device. Novice, unsophisticated, or technologically challenged individuals may have trouble embracing the idea of using a single media card associated with a particular electronic device. Some aspects that may be troublesome are the transferring of the digital content from the media card onto the host computer and then having to rename or organize the files once they are stored on the host computer. Often, the transferring of digital files onto the host computer must be renamed to identify the content appropriately. Additionally, the task of reformatting or deleting the content stored on the media card may be daunting to some users. Some users may prefer using a media card once.

Accordingly, there exists a need in the art for an improved media reader docking system.

### SUMMARY

In accordance with one embodiment of the present invention, a docking system for organizing media devices readable by a computer is contemplated. The system may include a media bay defined by a housing with a plurality of slots. Each of the slots may be receptive to a media device, and include a media reader that is linked to a dock connector port. Additionally, the system may include a dock that defines a plurality of receptacles. Each of the receptacles may secure one media bay, and include a media bay connector port that is engageable to the dock connector port of the corresponding media bay. The media bay connector ports, in turn, may be linked to an uplink port. The media bay may also be independently connectable to the computer via standard connections. The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a media reader dock and an associated media bay of a storage system constructed in accordance with the present invention;

FIG. 2 is a perspective view of the storage system as including a media reader dock with two media bays secured to the media reader dock;

FIG. 3 is a perspective view of the storage system including an optional second media reader dock which may be attached to another media reader dock thereof;

FIG. 4 is a perspective view of the storage system shown in Figure, further illustrating a media reader dock of the storage system with a cover removed for access to a connection port;

FIG. 5 is a top perspective view of an exemplary media bay of the storage system;

FIG. 6 is another top perspective view of the media bay shown in FIG. 5;

FIG. 7 is a front elevation view of the media bay shown in FIGS. 5 and 6;

FIG. 8 is a top perspective view of the media bay in an open position with a plurality of media cards inserted into respective ones of a plurality of slots thereof;

FIG. 9 is a top perspective view of the media bay in the open position similar to FIG. 8, but further illustrating a media card extending from one of the slots;

FIG. 10 is a side elevation view of the media bay in the open position;

FIG. 11 is a perspective view of another embodiment of the media reader block; and

FIG. 12 is a block diagram of the media bay in accordance with one embodiment of the present invention.

### DETAILED DESCRIPTION

The media reader docking system 10 of the present invention provides a user-friendly media reader capable of receiving a plurality of media cards for organizing digital content stored on each media card. The media reader docking system 10 may be configured to receive a plurality of media cards of the same format. In another embodiment, the media reader docking system 10 is configured to receive a plurality of media cards of various formats. The media reader docking system 10 may also be configured to receive a plurality of USB flash drives. The media reader docking system 10 may include one or more media bays 12. The media bay 12 may be configured to receive the plurality of media cards 14. The media bay 12 is the component of the media reader docking system 10 that may receive a plurality of media cards 14 of the same format, different format, or USB flash drives. The media bays 12 may be used to organize digital files based upon various characteristics as will be described in further detail below. For example, one media bay 12 may be configured to receive media cards 14 containing only digital photos. A second media bay 12 may be configured to receive media cards 14 containing only digital music.

The media reader docking system 10 may connect to a computer for interfacing media cards 14 with a host computer. The media reader docking system 10 may be connected to the computer using a Universal Serial Bus (USB) standard, IEEE 1394 interface, or various other serial cables to facilitate bidirectional communication between the media reader docking system 10 and the host computer. The media reader docking system 10 may also connect to the host computer wirelessly. The wireless communication may occur through a personal area network (PAN) and/or a wide area network. The media reader docking system 10 may further use different wireless protocols for short-range or long-range communications technology facilitating data transmission over certain distances from the media reader docking system 10 and the host computer. Further, the media reader docking system 10 may include a transceiver microchip to enable wireless communication. The media reader docking system 10 may also be battery operated or configured to plug into an electrical outlet for power if wireless communication is to be used.

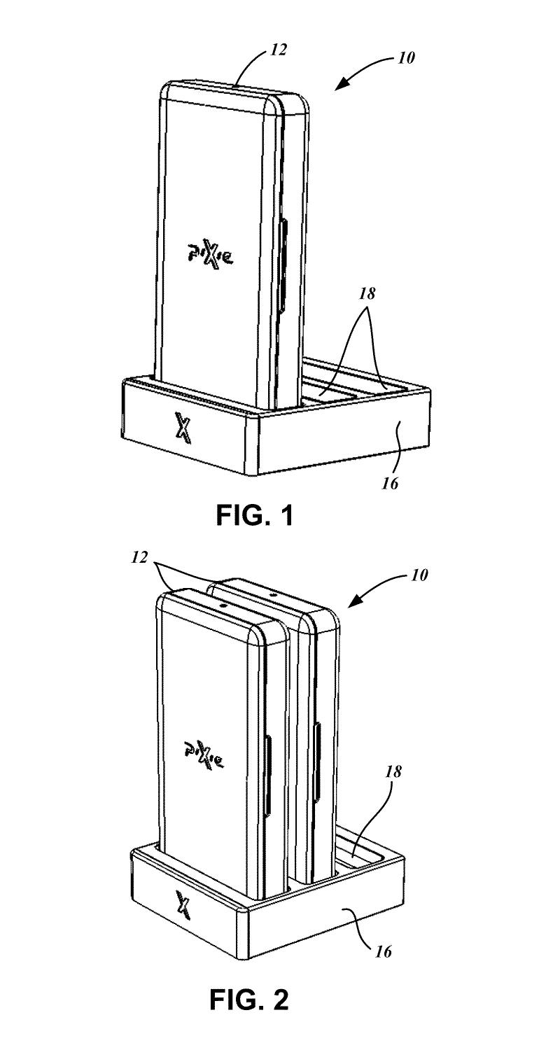

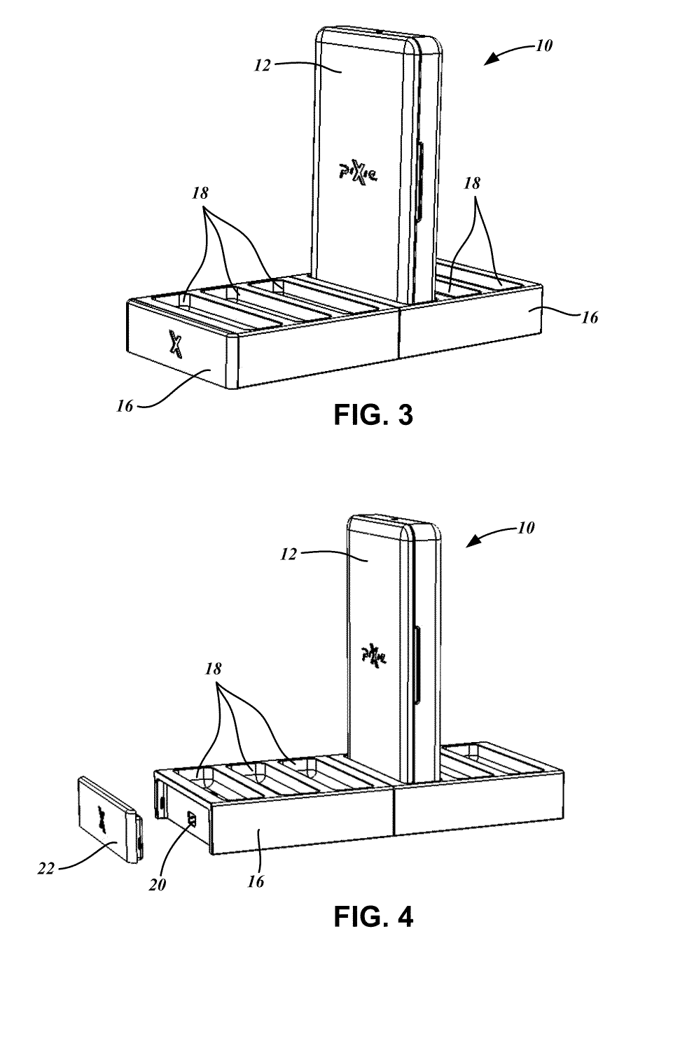

The media reader docking system 10 includes at least one dock 16. The dock 16 may be configured to sit upright on a flat surface. The dock 16 may also be sized for enhanced portability. The dock 16 of the media reader docking system 10 includes a plurality of receptacles 18. In one embodiment, the dock 16 may include up to three receptacles 18. Each receptacle 18 is configured to receive a complementary media bay 12. In this regard, the dock 16 may receive a plurality of media bays 12. For example, if the dock 16 includes three receptacles 18, the dock 16 may receive up to three media bays 12. The receptacles secure the media bays 12 to the dock 16. There are a variety of ways in which the receptacle 18 of the dock 16 may secure the media bay 12. For example, the receptacle 18 may include a protruding rib and the media bay 12 may include a complimentary aperture or slot configured to fit over the rib. However, other well known securing and connection means may be used. The media bay(s) 12 may be secured to the dock 16 in an upright or vertical position, as shown in FIGS. 1-4.

As shown in FIGS. 1-4, each dock 16 of the media reader docking system 10 has a generally quadrangular (e.g. square) configuration defining a top surface having the receptacles 18 disposed therein, on opposed, generally planar bottom surfaces, and four side surfaces which extend generally perpendicularly between the top and bottom surfaces. It is contemplated that each dock 16 will be provided with both a male connection port (not shown) and a female connection port 20 within respective ones of an opposed pair of the side surfaces or side walls thereof. As is shown in FIG. 4, both the male connection port and the female connection port 20 are normally covered by respective ones of a pair of removable end plates 22 which are releasably attached to respective ones of the side walls in which the male connection port and the female connection port 20 are located.

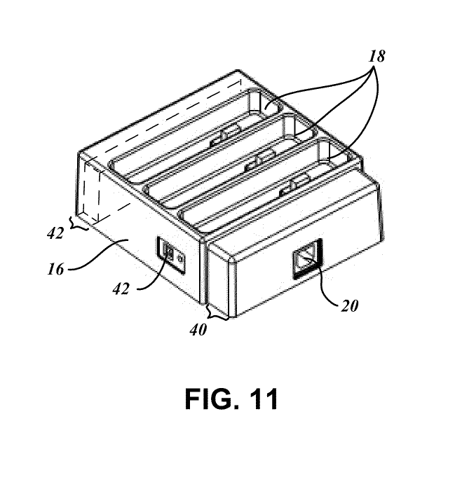

FIG. 11 depicts an alternative configuration of the dock 16. Again, the dock 16 has a generally quadrangular configuration with receptacles 18, but further defines a recessed section 40 and an opposed sleeve section 42. The recessed section 40 includes the female connection port 20, which by way of example only is a USB type B connector. The recessed section 40 cooperatively engages with the sleeve section 42 of another dock 16 in a mating relationship, such that multiple docks can be coupled as will be described in further detail below. In this regard, the sleeve section 42 may include the aforementioned male connection port that is disposed in axial alignment with the dock female connection port 20.

It is contemplated that the male connection port and female connection port 20 of each dock 16 allows the media reader docking system 10 to include multiple docks 16 which are operatively coupled to each other both mechanically and electrically. As a result, the data storage capacity of the docking system 10 is selectively expandable, based on the number of interconnected docks 16 included therein. For example, the docking system 10 may be configured to include up to three docks 16 which may be connected to each other in series. In this particular configuration, due to the inclusion of three receptacles 18 within each dock 16, the inclusion of four docks 16 in the docking system 10 provides a total of nine receptacles 18, each of which may accommodate a media bay 12 as indicated above.

In the docking system 10, the docks 16 are configured to attach and detach easily, thus allowing for the selective expansion or reduction in the size and storage capacity of the docking system 10. It is contemplated that the female connection port 20, or another connection port of the dock 16, will be configured to receive a USB cable or other serial cable that may be used to facilitate the electrical connection of the dock 16 to a host computer. In those instances where the docking system 10 includes a series of docks 16 connected to each other, only one serial cable may be necessary to connect all the docks 16 to the host computer, such cable being electrically coupled to the host computer and that dock 16 for which the female connection port 20 is accessible by the removal of the cover 22. To distinguish the male connection port and the female connection port 20 by their respective possible functions, the male connection port may also be referred to as a dock chaining port, while the female connection port 20 may be referred to as an uplink port. Depending on the specifics of the cabling utilized, however, in some cases it may be more logical to refer to the male connection port as the uplink port and the female connection port 20 as a dock chaining port.

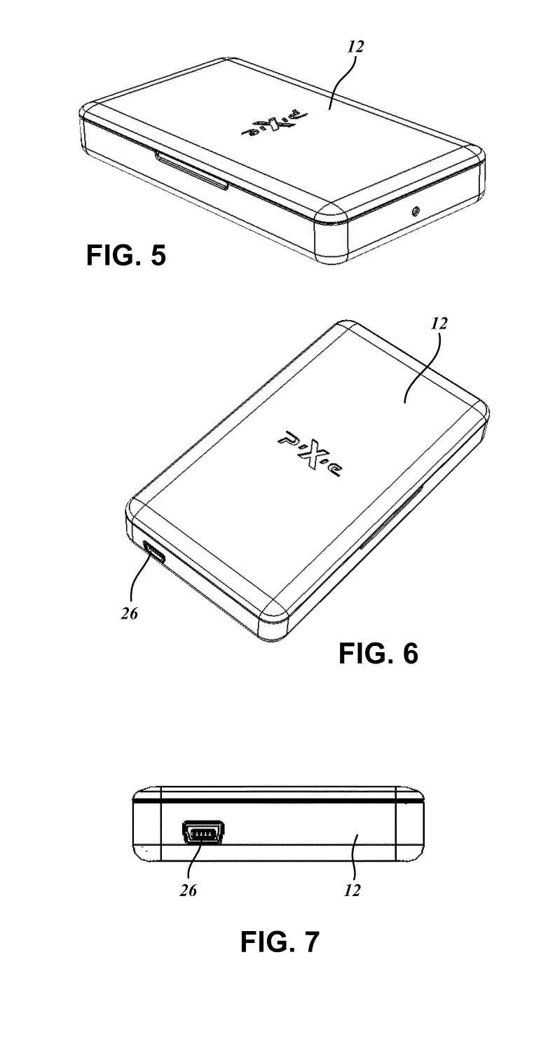

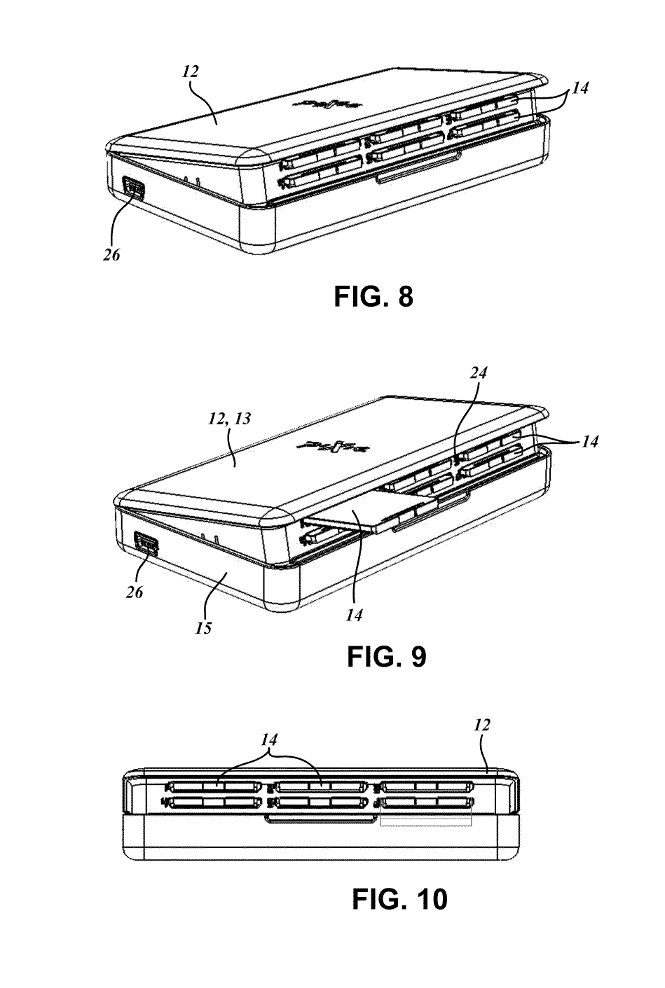

As indicated above, each media bay 12 of the docking system 10 is sized and configured to be extensible into a respective receptacle 18 of a corresponding dock 16. Each media bay 12 is constructed to be selectively movable between a closed or storage position (shown in FIGS. 5-7) and an open or access position (shown in FIGS. 8-10). Specifically, the media bay 12 is defined by a base housing 13 and an upper housing 15 that are in hinged relationship. The media bay 12 defines a plurality of slots 24 which are accessible when the media bay 12 is moved or actuated from its closed position to its open position. As is most apparent from FIGS. 8-10, each slot 24 is sized and configured to receive a media card 14. The media bay 12 preferably includes a total of six slots 24, though those of ordinary skill in the art will recognize that greater or less than six slots 24 may be included in each media bay 12 without departing from the spirit and scope of the present invention. According to one embodiment, each of the slots 24 have a push-push type connector in which the media card 14 is pushed in to secure the same to the slot 24, and pushed in again for removal.

It is contemplated that each media bay 12, and in particular the slots 24 thereof, may be configured to receive media cards 14 having different formats. As is apparent from FIGS. 5-7, the media card(s) 14 are secured within the interior of the media bay 12 when the same is moved to its closed position. It is contemplated that the media bay 12 may be selectively moved or actuated between its closed and open positions by pressing a button, latch, hinge or various other means.

As further seen in FIGS. 7-9, each media bay 12 further comprises a female connection port 26 which is disposed within one of the end surfaces thereof. As will be recognized by those of ordinary skill in the art, the female connection port 26 of each media bay 12 is adapted to be electrically coupled to a corresponding male connection port (not shown) which is disposed within the bottom of each of the receptacles 18 of the dock 16. Thus, it is contemplated that each media bay 12 will be advanced into a corresponding receptacle 18 within the dock 16 such that the female connection port 26 is effectively electrically coupled to the corresponding male connection port within the bottom of such receptacle 18, thus effectively facilitating the electrical connection of the media bay 12 (and hence the media card(s) 14 stored therein) to the dock 16.

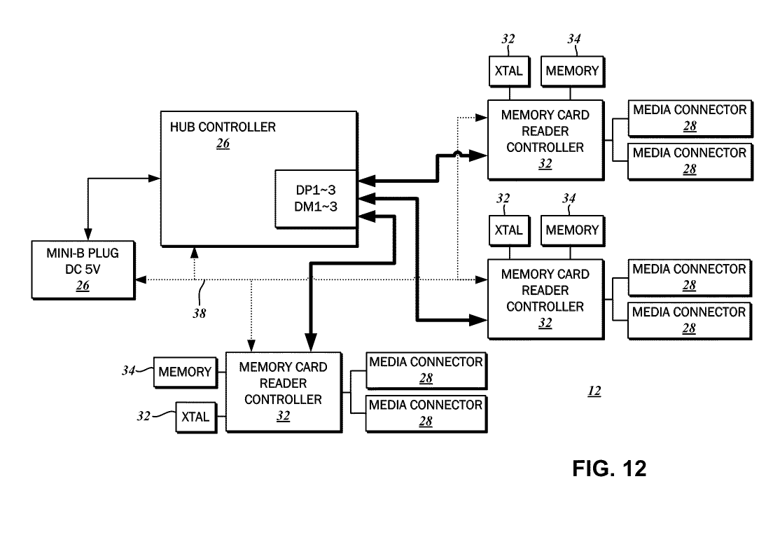

With reference to the block diagram of FIG. 12, various functional components of the media bay 12 will now be considered. Each of the physical slots 24 in the housing of the media bay 12 are understood to include a media connector 28, which physically and electrically interfaces with the media cards 14. The pin configurations of the media connector 28 are specific to the media card standard that it is configured to receive. For example, in order to interface with a SecureDigital (SD) card, the media connector has an SD card pin configuration.

In one embodiment of the present invention, each pair of media connectors 28 is connected to a single memory card reader controller 30. It is understood that the memory card reader controller 30 communicates with flash memory devices connected thereto, and provides a standard interface such as USB with which the computer can use to read data from and write data to the memory device. By way of example only and not of limitation, one memory card reader controller 30 that may be utilized is the SM334 integrated circuit device from SiliconMotion, Inc. Each memory card reader controller 30 has a crystal oscillator 32 providing a clock frequency to the internal processing unit. Additionally, a programmable read-only memory 34 can be connected to the memory card reader controller, which may store a specific vendor identifier (VID) and product identifier (PID) that allows the media bay 12 to be properly identified by the computer and the software program as will be described in further detail below.

Each of the memory card reader controllers 30 is connected to a hub controller 36. As indicated above, the memory card reader controllers 30 in accordance with one embodiment provides a USB interface to the memory cards. The transceiver in the hub controller is understood to multiplex these individual USB signals into a single one for the uplink port/female connection port 26. Along these lines, a similar hub controller may be included in the dock 16 to multiplex the several downstream USB interfaces thereof, including the media bays 12 and the dock chaining port. According to one embodiment, the hub controller 36 may be a GL850G integrated circuit device from Genesys Logic, Inc.

Per the USB specifications, power can be provided to downstream devices from the host interface. Thus, as illustrated in FIG. 12, this power signal is taken from the uplink port 26, and routed to each of the hub controller 30, and the memory card reader controller 30 via a power bus 38. It is also understood, however, that the power supplied by the host interface may be insufficient, and may be provided from via an external adapter as indicated above. As best illustrated in FIG. 11, the dock 16 can include a power adapter port 44, to which a power adapter may be connected. In such case, the uplink port 26 may also be in electrical communication with the power adapter port 44.

The media bay 12 may be connected to the host computer without being secured to the dock 16. In this respect, the media bay 12 may be connected to the host computer via a serial cable such as a USB cable electrically connected to the female connection port 26 thereof. In this scenario, the media bay 12 may function as a portable memory case separate from the dock 16. The media bays 12 may be configured as single media card readers for a plurality of media cards 14 of the same format. The media bays 12 may also be configured as multi card readers accepting media cards of various formats. Additionally, the media bays 12 may have different combinations. For example, some media bays 12 may be 9 in 1 media readers, 8 in 1, 7 in 1, etc. The media reader docking system 10 may accept a large quantity of media cards 14. For example, if the dock 16 includes at least three receptacles 18 and each media bay 12 includes six slots 24, then the media reader docking system 10 may receive up to eighteen media cards 14. If three docks 16 are connected in series, a total of fifty-four media cards 14 can be accommodated by the docking system 10. After the media bay 12 is inserted into a particular receptacle 18 of the dock 16, digital media stored on the media bay 12 may be viewed, transferred, organized, shared, and so forth.

The ability to use different media bays 12 and interchange the media bay(s) 12 secured to the dock(s) 16 allows for improved organization capabilities of a large quantity of media cards 14. For example, one media bay 12 may be dedicated to media cards 14 used to store digital pictures taken with a digital camera. Another media bay 12 may be dedicated to media cards 14 used to store digital music that may exist on a music playing device, recorded, or downloaded. A third media bay 12 may be dedicated to media cards 14 used to store digital video taken with a digital camcorder. Therefore, the media bays 12 or the docks 16 may be organized by the type of electronic device the user prefers. For example, the user may prefer at least three media bays 12 for digital photos and two media bays 12 for digital music.

Alternatively, each media bay 12 may be dedicated to media cards 14 from a particular device. For example, if a user has three media cards 14 for a particular digital camera, three media cards 14 for a digital camcorder, and three media cards 14 for an mp3 player, all these media cards 14 may be interchangeable and compatible with the various devices. However, formatting the media card 14 for one device will make sure that the media card 14 is set up and structured specifically for that the device. If a different media card 14 is used for the device, a problem may arise since that particular media card 14 may be formatted for a different device even though it is compatible with the device in which it is being used. Thus, the user may have to reformat the media card 14 prior to using it on the second device. To avoid this possible constraint, the user may set aside a group of media cards 14 dedicated for a particular device, such protocol being easily accommodated by the docking system 10.

The media reader docking system 10 may also include a software program. The software program may be used to organize the digital content stored on the media bays 12 by way of the media cards 14. The software program may be used to name the media bays 12 based on the digital content stored within each media bay 12. In another example, various types of digital content may be stored in one media bay 12. The name given to a particular media bay 12 may remind the user of the information stored therein. Additionally, the software program may be used to edit the content stored within the media cards 14 stored within each media bay 12. The software program may also facilitate the interface between the media reader docking system 10 and the host computer. Each media bay 12 may be assigned an icon to help identify the type of content intended to be received by the particular media bay 12.

The media reader docking system 10 is used to access digital content of many different varieties in an organized manner on the host computer. The media reader docking system 10 is connected to the host computer through a serial cable as indicated above. The dock(s) 16 of the media reader docking system 10 may then receive a plurality of media bays 12. Upon receiving the media bays 12, each media bay 12 may be viewed on the host computer. The contents of the media bay 12 may be selected by clicking on an icon appearing on the host computer. The icon is representative of the media bay(s) 12 secured to the dock(s) 16. Subsequent to the selection of the media bay 12, the media card(s) 14 stored in the media bay(s) 12 may be viewed. After selecting the media bay 12, an icon may appear for each media card 14 stored within the selected media bay 12. Selecting one of the media cards 14 provides access to the files stored on that media card 14. Whether or not a particular media card 14 is selected, the software program may provide a list of the digital content stored on each media card 14 for the media bay 12 that is selected. This list may be viewed on a monitor connected to the host computer.

After reviewing the listing of the files stored in the media bay 12 via the media cards 14, the digital content is selected on the host computer. In this regard, if the user would like to view pictures from a particular file, listen to music stored on a different media card 14, or view a video the user simply selects the file with the appropriate digital content. The digital content stored on the selected media card 14 may be erased, edited, or transferred to the host computer. Other options may also include the ability to email the file or generate a slideshow of the digital content. This provides an organized digital content album that may be viewed on the host computer with or without requiring the transfer of the digital content stored in each media card 14 within each media bay 12. This may prove especially useful for novice users for organizing digital content from various electronic devices using a plurality of media cards 14. Additionally, the files may be transmitted to various social networking sites such as Facebook.com and Flickr.com.

The software program may enable information associated with the files stored on the media cards 14 to be listed on the host computer. This information may include the media card name, file names, size of the digital content stored on the media card 14 and the number of files existing on the media card 14. Furthermore, the media reader docking system 10 allows for easy maneuvering between files on different media cards 14. Rather than having to replace the media card 14 with a different media card 14 as required by conventional media readers, the media card 14 is already loaded into a media bay 12 which is then selected from the menu which may appear on the host computer. In the example wherein the media reader docking system 10 is expanded to include three docks 16 and twelve media bays 12, a library of digital content may be generated using the plurality of media cards 14. Instead of organizing the digital content on the host computer, the media cards 14 are simply inserted into the slots 24 of the media bay 12. The interface provided by the software program allows the user to see each media bay 12 secured to the dock(s) 16. In this example, the user potentially has access up to fifty four media cards through a single mouse click.

Both the dock(s) 16 and the media bay(s) 12 are compact, fast and versatile, and designed for portability. Equipped to handle most memory card requirements, the media reader docking system 10 facilitates the transfer of photos, music, and data between mobile phones, cameras, and computers. The media card reader docking system 10 also allows for fast, easy transfer of music, videos, photos, or documents through a high-speed USB 2.0 interface. With a versatile media card reader, transferring data to and from memory cards in digital cameras, camcorders, mobile phones, personal digital assistants (PDA), smartphones, or GPS may be more convenient for some users.

The media bays 12 may also be configured to receive flash based memory devices, USB flash drives, and non-flash memory devices. Electronic devices are typically designed with minimal or no internal memory capacity to save manufacturing costs. Thus electronic devices such as digital cameras, camcorders, and digital music players appear to be moving away from increasing the total internal memory. This trend may correspond to the increased capacity and reduction of costs for media cards 14 capable of storing a large quantity of digital content. Indeed with the greater acceptability and reduction in costs the use of media cards 14 is becoming more commonplace. Typically the internal memory associated with one of the above described devices is inadequate and must be supplemented with memory from a media card 14. The movement away from internal hard drives in electronic devices may increase reliance on media cards 14 for storing digital content. Consumers are relying on media cards 14 for storage of their digital content on many electronic devices such as digital music players, camcorders, PDA's, Smartphones, laptops, cameras and the like.

Using a single media card 14 per device may be disadvantageous. Novice users may be frustrated with certain requirements such as reformatting of media cards 14 in order to store more digital data onto a particular media card 14. Sometimes even if the digital content is deleted from the media card 14, additional data may not be stored on the media card 14 until the media card is reformatted. Furthermore, it is recommended to stop using a media card 14 if information is accidentally deleted or there is a card error message. Further use may result in the permanent loss of the digital content. Instead, the media card 14 may be preserved to attempt to save the digital content within. The fewer write and re-write cycles associated with the addition or removal of data the longer the media card 14 may be preserved. Erasing or adding content on the media card 14 may eventually wear it down. The use of more than one media card 14 may also be recommended to avoid the lack of a backup media card 14 in case one of the media cards 14 fails. Therefore, some users may prefer using a media card 14 once and then inserting the media card 14 into a media bay 12 to generate an album or collection of digital content stored on a plurality of media cards 14. Some users prefer to avoid the hassle of re-using media cards 14 by deleting information stored therein.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the present invention.

What is claimed is:

1. A docking system for organizing media devices readable by a computer, the system comprising:
a media bay defined by a housing with a plurality of slots each receptive to a media device, the slots including a media reader linked to a dock connector port; and
a dock defining a plurality of receptacles each for securing one media bay, each receptacle including a media bay connector port engageable to the dock connector port of the corresponding media bay, the media bay connector ports being linked to an uplink port.

2. The docking system of claim 1, wherein the dock includes a dock chaining port connectable to the uplink port of another dock.

3. The docking system of claim 2, wherein:
the dock chaining port is a male connector; and
the uplink port is a female male connector.

4. The docking system of claim 2, further comprising:
a first end plate attachable to the dock over the dock chaining port; and
a second end plate attachable to the dock over the uplink port.

5. The docking system of claim 1, wherein the slots of the media bay are uniform for a single type of media devices.

6. The docking system of claim 1, wherein the slots of the media bay are variable for different types of media devices.

7. The docking system of claim 1, wherein the housing of the media bay has an open position exposing each of the slots and a closed position concealing each of the slots.

8. The docking system of claim 1, wherein the uplink port is connectable to the computer over a serial data link.

9. The docking system of claim 8, wherein the serial data link is a Universal Serial Bus (USB) interface link.

10. The docking system of claim 8, wherein the serial data link is an IEEE 1394 interface link.

11. The docking system of claim 1, wherein:
a one of the slots is a serial data link connector; and
one of the media devices is a memory module including a corresponding adapter engageable to the serial data link connector.

12. The docking system of claim 1, wherein one of the media devices is a flash memory module.

13. The docking system of claim 12, wherein the media bay includes a flash memory card reader controller cooperating with the media reader.

14. The docking system of claim 12, wherein the media bay includes a hub controller in communication with the flash memory card reader controller, the hub controller being connected to the dock connector port.

15. The docking system of claim 1, wherein the dock further includes:
a communications hub having downstream connections to the media bay connector ports and an upstream connection to an uplink port.

16. The docking system of claim 15, wherein the dock chaining port is one of the downstream connections of the communications hub.

17. A multiple media reader device, comprising:
a base housing;
a data transfer port disposed on the base housing; and
an upper housing partially enclosable within the lower housing, the upper housing including a plurality slots each receptive to a media device, the slots having media readers linked to the data transfer port;
wherein a first position of the lower housing relative to the upper housing defines an open configuration exposing each of the slots, and a second position of the lower housing relative to the upper housing defines a closed configuration concealing each of the slots.

18. The multiple media reader device of claim 17, wherein each of the slots includes a push-push type media connector.

19. The multiple media reader device of claim 17, wherein the base housing is in a hinged relationship to the upper housing.
